(19) United States
(12) Patent Application Publication
(10) Pub. No.: US 2014/0104389 A1
(43) Pub. Date: Apr. 17, 2014

(54) Methods and Camera Systems for Recording and Creation of 3-Dimension (3-D) Capable Videos and 3-Dimension (3-D) Still Photos

(71) Applicant: Medha Dharmatilleke, Mason, OH (US)

(72) Inventor: Medha Dharmatilleke, Mason, OH (US)

(21) Appl. No.: 13/865,307

(22) Filed: Apr. 18, 2013

Related U.S. Application Data
(63) Continuation of application No. PCT/SG2010/000341, filed on Sep. 16, 2010.

(30) Foreign Application Priority Data
Sep. 16, 2010 (SG) 201006753-6

(51) Int. Cl. H04N 13/02

(52) U.S. Cl. CPC H04N 13/026
USPC 348/46; 29/592.1

(57) ABSTRACT

A camera system is disclosed which can produce 2-Dimensional (2-D) video movies and still photographs having all the objects in the area of its view to be fully focused. Due to the fact that all the objects including the background is fully focused with high image quality, these video movies and still photographs can easily be converted to high quality 3-Dimensional (3-D) video movies and 3-D still photographs. The conversion may be done by using software or hardware or a combination of both software and hardware.

### BACKGROUND

### Description of Related Art

The cameras having the standard auto focus is only capable of focusing only a given area which is within its range of view. The standard auto focus camera is not able to simultaneously focus all the objects which are near (eg. 5 cm distance from camera) and far (eg. up to infinity or a few tens of meters) onto the imaging plane of the image sensor or photographic film of the camera. This makes it impossible or very difficult for software to create a good quality 3-Dimensional video from a 2-D video, captured using a standard auto focus camera. There are software that are capable of creating 3D video from 2D video. Also software and hardware combinations are available to create 3D video from 2D video. A common practice is to use two or more cameras to record video of a single scene and then later combine the two individual video recordings done by the two or more cameras, into one video in order to produce the 3 Dimensional video movies and still photographs.

Drawback of this method is the increase in the number of camera components required and there by the increase in the price of the video/still camera capable of capturing 3 Dimensional capable video and still images.

In addition, the requirement of post processing to create the 3D video from the individual video recordings makes it time consuming and requires additional equipment to create a 3D movie or video. The above requirements make it impossible for the fabrication of low cost 3D capable video or still cameras. With increasing demand for low cost 3-Dimension miniaturized video and still capture capable cameras, a low cost camera system which is capable of capturing 3-Dimension video movies and still photos with and optical system incorporated to an imaging sensor is desired.

### SUMMARY OF EMBODIMENTS OF THE INVENTION

One embodiment of the invention relate to methods and systems of making a low cost video camera and imaging (still capture) camera which is capable of recording video and still images, which can be converted to high quality 3 Dimensional videos and 3-D still photos.

Various arrangements may be envisaged to achieve focusing of the whole area, which is visible through the optical system of the camera onto the image sensor or film, used to capture the video movie or still photograph.

Another embodiment provides an optical imaging lens system which is capable of simultaneously focusing light rays originating from objects disposed at various distances on to a first focal plane which is maintained at a fixed distance from the lens assembly. Hence, embodiments of the invention enable imaging devices in small and compact form factor to produce quality 3-Dimension capable video and still images.

The camera system disclosed herein provide 2-Dimension videos and still images which fulfills the requirement of having being able to form a 3D perspective image on the image sensor with all the objects in the field of view to be fully focused and have no blur areas, in order to obtain high quality 3-Dimension video and still images

Here, what is meant (intended) by the term 3-Dimension capable is to generate 3-Dimension video movie or 3-D still photographs using a combination of software and hardware, from the original 2-Dimension video movie or still photograph. The application areas are in the mobile communications such as mobile phones, laptops, smart phones, mobile multimedia devices, web cams, camcorders, cameras, digital cameras, photographic film camera, medical camera and compact camera modules.

The key to converting a 2-Dimension video or still image to a high quality 3-D video or still image should have all the objects which are near and far in the field of view should be fully focused and should not have blur regions in the 2-D video or 2-D still photo

A 3D display where the 3D can be observed without using special glasses is disclosed.

### BRIEF DESCRIPTION OF THE DRAWINGS

FIG. (1) illustrates an optical camera system assembly having a lens assembly with the capability of forming 3 Dimensional perspective image of the objects which are in it's field of view, on the image sensor of a camera module. The 3 Dimensional perspective image will have both far and near objects simultaneously focused on the image capture sensor placed at the focal plane. Here the optical lens system has multiple components.

FIG. (2) illustrates an optical camera system assembly having a lens assembly with the capability of focusing both far and near objects simultaneously and the image capture sensor placed at the focal plane. Here the optical lens system has multiple components.

FIG. (3) illustrates flow chart showing the process flow for viewing 2-D video movies and 2-D still photographs in 3-Dimensions directly from mobile phone, after conversion to 3-Dimensions.

FIG. (4) Illustrated the schematic of 3D display 400. On this 3D display, 3D can be observed without using special glasses (i.e. glass free 3D).

FIG. (5) Illustrated the schematic of 3D display 500. On this 3D display, 3D can be observed without using special glasses (i.e. glass free 3D).

FIG. (6) Illustrated the schematic of 31) display 600. On this 3D display, 3D can be observed without using special glasses (i.e. glass free 3D).

FIG. (7) illustrates an optical camera system assembly having a lens assembly with the capability of forming 3 Dimensional perspective image of the objects which are in it's field of view, on the image plane 730 or focal plane 730 or image sensor of a camera module. The 3 Dimensional perspective image will have both far and near objects simultaneously focused on the image capture sensor placed at the focal plane. Here the optical lens system has multiple components.

### DETAILED DESCRIPTION OF ILLUSTRATIVE EMBODIMENTS

In the following description, numerous specific details are set forth in order to provide a thorough understanding of various illustrative embodiments of the invention. It will be understood, however, to one skilled in the art, that embodiments of the present invention may be practiced without some or all of these specific details. In other instances, well known process operations have not been described in detail in order not to unnecessarily obscure pertinent aspects of embodiments being described.

One embodiment is an optical camera system comprising: a lens assembly, wherein the lens assembly create a 3 dimensional perspective view which is formed on a 2 dimensional plane or 3 dimensional perspective view which is formed on a 3 dimensional area or 3 dimensional perspective view which is formed on a 3 dimensional object, of the objects or scenery which are in the field of view of the lens assembly or 3 Dimensional still or video image or a 3 Dimensional perspective image or a 3 Dimensional perspective video or a 3 Dimensional perspective view of the objects or scenery which are in the field of view of the lens assembly, on to an image plane or image sensor. The 3 Dimensional image or a 3 Dimensional perspective or a 3 Dimensional perspective view of the objects or scenery which are in the field of view of the lens assembly is formed on a first focal plane which is maintained at a fixed distance from the lens assembly, wherein the image sensor is placed, in order to record 3 Dimensional perspective video or still images. The camera system can convert the 3 dimensional perspective view which is formed on a 2 dimensional plane or 3 Dimensional image or a 3 Dimensional perspective or a 3 Dimensional perspective view of the objects or scenery to high quality 3-Dimensional video and still images using a combination of software and hardware. The lens assembly simultaneously focus a plurality of light rays originating from a plurality of distances, onto the image sensor.

In one embodiment the 3 Dimensional image or a 3 Dimensional perspective or a 3 Dimensional perspective view of the objects or scenery which are in the field of view of the lens assembly is formed on a first focal plane which is maintained at a fixed distance from the lens assembly, wherein the image sensor is placed, in order to record 3 Dimensional perspective video or still images and/or to record 2 dimensional video and/or still images having a 3 Dimensional perspective view. The recorded 3 Dimensional perspective view is converted to a format of which can be viewed in 3D (i.e. 3 Dimensions) on a appropriate 3D display.

One embodiment is a camera system having a special optical system and image sensor for capturing video and still images which are fully focused. The special optical system consists of a lens assembly which is operable to simultaneously focus light rays originating from various distances onto a first focal plane. More particularly, parallel, convergent or divergent light rays from objects at near distances (eg. at least a few millimeters), and parallel or near parallel light rays from far object or objects at near infinity distances may be simultaneously focused onto a first focal plane while maintaining quality focus of a formed imaged within an acceptable tolerance limit.

The imaging surface of the image sensor or photographic film is placed at the first focal plane. In certain embodiments, a separation distance between a second focal plane where an image of a near object may be formed and a third focal plane where an image of a far object may be formed should have an acceptable tolerance limit. The first focal plane may be suitably maintained at a fixed distance from the lens assembly whether the optical system is focusing on objects at near distances, or objects at near infinity distances, or both. Thus, when focusing objects at various distances, the optical system does not require varying a relative distance between the lens assembly and a first focal plane or an image plane on which images of the objects are focused onto be captured by an image sensor or photographic film. In other words, the first focal plane, where images are formed for capturing of objects disposed at various distances, including near distances and near-infinity distance, is fixed relative to the lens assembly. Since a relative movement between lenses is not necessary when performing a focus function, the optical system would require less space and less power. The image plane may be provided as part of an image sensor, such as but not limited to, a charged couple device (CCD) sensor, a complementary metal oxide semiconductor (CMOS) sensor and a photographic film.

The video and still image captured by the camera system disclosed here in will have all the objects in its field of view to be fully focused. The feature of this camera being able to provide fully focused video and still images of all objects in its field of view enables the creation of high quality 3-D videos and still images by conversion of the video and still images using software, hardware or a combination of both.

One embodiment is an optical camera system comprising: a lens assembly, wherein the lens assembly is operable to simultaneously focus a plurality of light rays originating from a plurality of distances, onto a first focal plane which is maintained at a fixed distance from the lens assembly wherein

the video or still images obtained from the camera system can be converted to high quality 3-Dimensional video and still images using a combination of software and hardware.

In one embodiment, the camera system disclosed herein provide 2-Dimension videos and still images which fulfills the requirement of having being able to form a 3D perspective image on the image sensor having all the objects in the field of view of the lens, to be fully focused and have no blur areas, in order to obtain high quality 3-Dimension video and still images

In one embodiment, a transparent substrate or sheet, consisting of a collection of lenticular lenses or lenticular lens array and a collection of parallel lines array is combined together to form the 3D display, which provides and enables the stereoscopic view (vision), to the person viewing the content displayed on the 3D display, which enables 3D vision or 3D viewing of content shown in the 3D display or stereoscopic display disclosed herein.

In one embodiment, a transparent substrate or sheet, consisting of a collection of lenticular lenses or lenticular lens array and a collection of parallel lines array is combined together to form the 3D display, which provides and enables the stereoscopic view (vision), to the person viewing the content displayed on the 3D display, which enables 3D vision or 3D viewing of content shown in the 3D display or stereoscopic display disclosed herein is attached onto the display or display screen of the camera, mobile phone, ipad, tab, laptop, PC monitor, or other applicable device. A software application is to be used with the display in order to transform the image or video, to a compatible mode with the display, in order to achieve the desired stereoscopic view and there by provide the 3D viewing experience to the viewer.

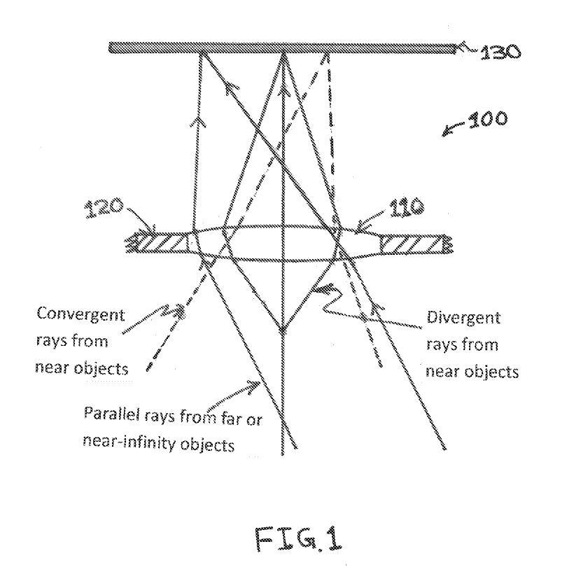

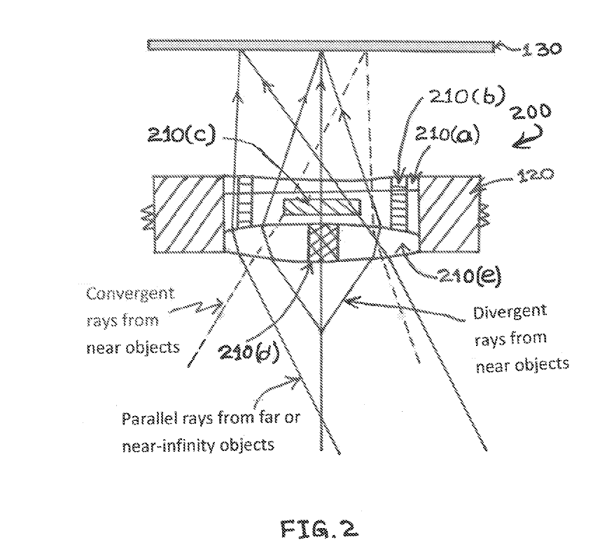

FIG. 1 and FIG. 2 show cross sectional views of the devices explained.

FIG. 1 illustrates an optical system according to one embodiment of the invention. The optical system 100 includes a lens 110. A retainer structure 120 as illustrated, but not limited as such, may be provided to support the lens 110. Threads may be provided on the retainer structure 120 to facilitate installation or mounting of the optical system 100 to an external body or device.

As illustrated, parallel, convergent or divergent light rays from near objects, and parallel or near parallel light rays from objects at near infinity distances may be simultaneously focused onto a first focal plane or image plane or image sensor 130 which may be maintained at a fixed distance from the lens assembly 110. FIG. 2 illustrates the embodiment of FIG. 1 in cooperation with an array of optical elements within the lens assembly 200.

The lens assembly 200 includes an array of optical elements, 210 (a), 210 (b), 210 (c), 210 (d), 210 (e), but not limited to the illustration.

The number of optical elements, dimensions and orientation of each element is not limited to illustration.

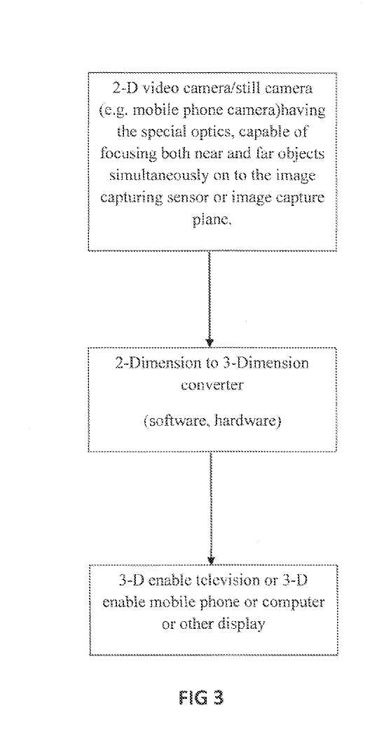

FIG. 3 illustrates an example flow chart for using the mobile phone to directly playback video movies and still images which can be viewed as 3-D video movies and 3-D still photos through a suitable display 330. The high quality 2-D video or 2-D still photo captured by the camera system disclosed herein is converted to 3-D video or 3-D still photo by the converter 320. The mobile phone 310 is equipped with a 2-D video and still camera with the optics capable of focusing near and far objects simultaneously onto the image capture sensor or image capture plane, illustrated in FIG. 1 and FIG. 2, but not limited to these illustrations.

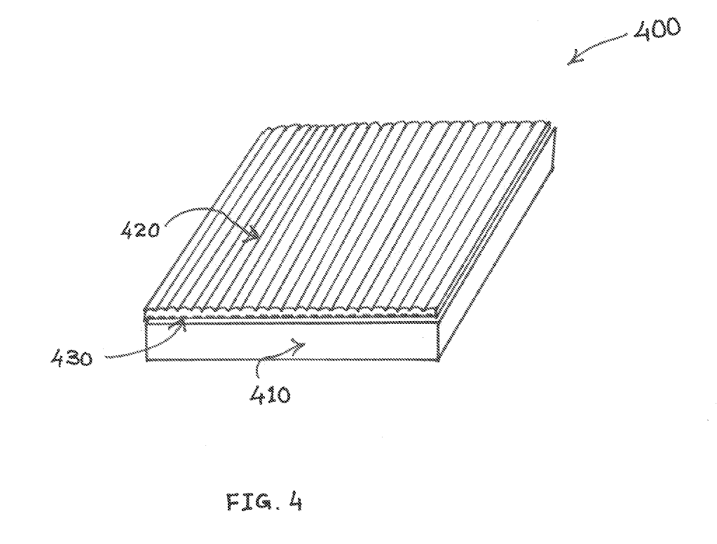

FIG. 4 Illustrated the schematic of 3D display 400. On this 3D display, 3D can be observed without using special glasses (i.e. glass free 3D). Lenticular lens array 420 and the parallel lines array 430 is attached on to the LED or LCD or any other display 410.

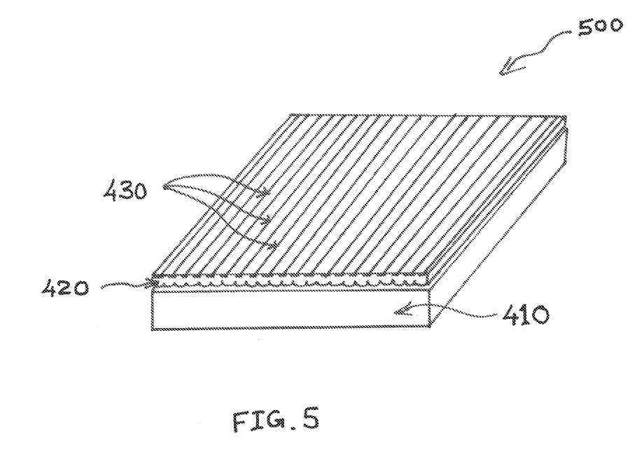

FIG. 5 Illustrated the schematic of 3D display 500. On this 3D display, 3D can be observed without using special glasses (i.e. glass free 3D). Lenticular lens array 420 and the parallel lines array 430 is attached on to the LED or LCD or any other display 410.

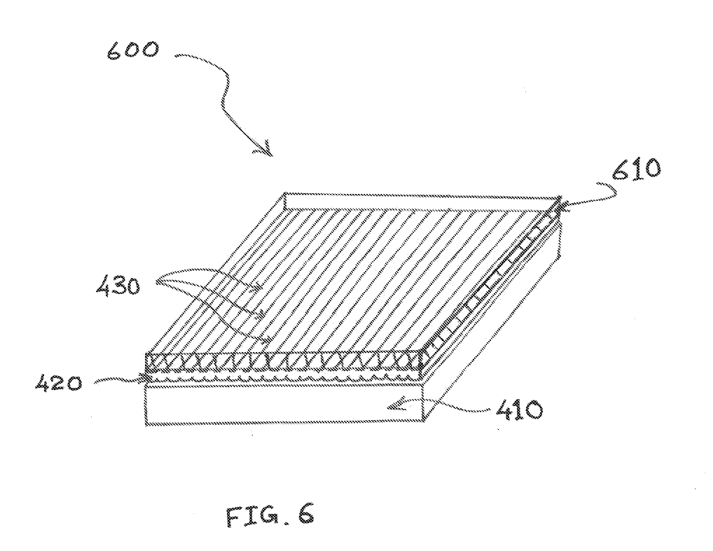

FIG. 6 Illustrated the schematic of 3D display 600. On this 31) display, 31) can be observed without using special glasses (i.e. glass free 3D). Lenticular lens array 420 and the parallel lines array 430 is attached on to the LED or LCD or any other display 410. The lenticular lens array 420 and the parallel lines array 430 is attached on to the LED or LCD or any other display 410 from one side and the other side is attached to another substrate 610.

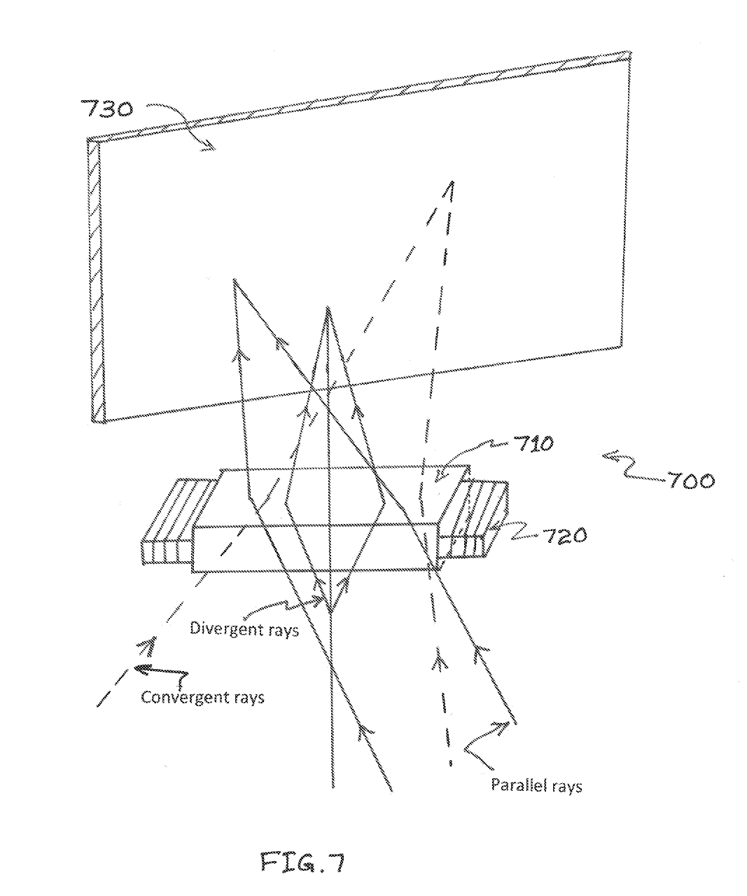

FIG. 7 show 3 Dimensional views of the devices explained.

FIG. 7 illustrates an optical system according to one embodiment of the invention. The optical system 700 includes a lens assembly and/or optical module 710. A retainer structure 720 as illustrated, but not limited as such, may be provided to support the lens assembly and/or optical module 710. Threads may be provided on the retainer structure 720 to facilitate installation or mounting of the optical system 700 to an external body or device.

As illustrated, parallel, convergent or divergent light rays from near objects, and parallel or near parallel light rays from objects at near infinity distances may be simultaneously focused onto a first focal plane or image plane or image sensor 730 which may be maintained at a fixed distance from the lens assembly and/or optical module 710.

What is claimed is:

1. An optical camera system comprising:
a lens assembly, wherein the lens assembly is to create a 3 Dimensional perspective view which is formed on a 2 Dimensional plane or 3 Dimensional perspective view which is formed on a 3 Dimensional area or 3 Dimensional perspective view which is formed on a 3 Dimensional object, of the objects or scenery which are in the field of view of the lens assembly.
a lens assembly, wherein the lens assembly is to create a 3 Dimensional still image or video image or a 3 Dimensional perspective image or a 3 Dimensional perspective video image or a 3 Dimensional perspective view, of the objects or scenery which are in the field of view of the lens assembly, on to an image plane or image sensor.
The 3 Dimensional image or a 3 Dimensional perspective or a 3 Dimensional perspective view of the objects or scenery which are in the field of view of the lens assembly is formed on a first focal plane which is maintained at a fixed distance from the lens assembly, wherein the image sensor is placed, in order to record 3 Dimensional perspective video or still images and/or to record 2 dimensional video and/or still images having a 3 Dimensional perspective view.
The camera system can convert the 3 Dimensional image or a 3 Dimensional perspective or a 3 Dimensional perspective view of the objects or scenery to high quality 3-Dimensional video and still images using a combination of software and hardware.
The lens assembly simultaneously focus a plurality of light rays originating from a plurality of distances, onto the image plane or image sensor or image sensor placed on the image plane.

2. The camera system of claim 1, produces fully focused 3 Dimensional image or a 3 Dimensional perspective or a 3 Dimensional perspective view of the objects or 3 Dimensional video or 3 Dimensional perspective movies of scenery which are in the field of view of the lens assembly and-are at near and far distances to the camera.

3. The video movies and still photographs obtained using the system of claim 1 have very sharp and clear images of the objects which are at both near distance and far distance.

4. The 2-D video movies and 2-D still photographs obtained using the system of claim 1 is converted to 3-D video movies and 3-D still photographs. The converted 3-D video movies and 3-D still photographs of claim 20 can be viewed using a 3-D enabled television or other compatible display device.

5. The 2-Dimensional video recording or still photo captured with the camera system of claim 1, is directly viewed in 3-Dimensions on mobile phone or television after conversion to appropriate format using software or hardware or a combination of both software and hardware.

6. With a combination of software and hardware, a television may convert the 2-Dimension video content and 2-Dimension still content captured in real time by the camera system of claim 1, to 3-Dimension video and 3-Dimension still images.

7. The system of claim 1, wherein a ZOOM function is incorporated to the camera system.

8. The optical lens assembly of claim 1 comprising:
a lens assembly;
a plurality of focal planes, and
the plurality of focal planes comprising a first focal plane, wherein light rays from objects at near distances and light rays from objects which are at far distances are simultaneously focused in to the first focal plane and wherein the first focal plane is at a fixed distance from the lens assembly.
a first focal plane wherein light rays from objects at near distances and light rays from far distances are focused simultaneously, a second focal plane where images of objects of near distances form and a third focal plane where images of far distances form, wherein the optical system produces 2-D images of objects from far and near distances, wherein the 2-D images can be converted to 3-D images using software or hardware, and wherein the first focal plane is at a fixed distance from the lens assembly.

9. The optical system of claim 8, wherein the separation distance between the second focal plane and the third focal plane has a tolerance of about +/−300 micrometers.

10. The optical system of claim 1, which produces fully focused images of objects from near and far distances.

11. A method of obtaining 3-D images or movies of objects in claim 1, comprises use of an optical system comprising:
a lens assembly;
a plurality of focal planes comprising first, second and third focal planes, first focal plane located in between the second and third focal planes, wherein the first focal plane is located at a fixed distance from the lens assembly, and wherein the first focal plane is at a fixed distance from the lens assembly,
obtaining a 2-D images or 2-D movies of objects using the optical system; and
converting the 2-D images or 2-D movies of objects to 3-D images of objects or 3-D movies of objects using hardware or software.

12. The devices which can use the camera system disclosed in claim 1 is from the group consisting of a television, a handheld phone, a handheld device, a mounted screen, a movie screen, a clear surface, videocamera, a camera, a reading device, a navigation system, a global positioning system (GPS), a clear glass, an opaque glass, a wall, projection device, computer monitor including laptop monitor or a desktop monitor, electronic reader device, electronic book or electronic newspaper, a billboard, display device, and a mounted screen on a moving object.

13. The camera system of claim 1, consists a 2-D to 3-D converter, and a optional 3D-enable monitor or display.

14. The camera system of claim 1, consists of a optical lens module producing 2-Dimension videos and still images which fulfils the requirement of having being able to form a 3D perspective image or image showing the 3D perspective view, on the image sensor with all the objects in the field of view of the lens, to be fully focused and have no blur areas and/or non focussed areas, in order to obtain high quality 3-Dimension video and still images.

15. The 3-D perspective video movies and 3-D perspective still photographs of claim 14 can be viewed on a computer monitor, laptop, mobile phone, smart phone, portable media player, or any other device capable of displaying 3 Dimensional video movies and 3 Dimensional still photographs without the dedicated eye glasses on a passive 3 Dimensional display device.

16. The passive 3 Dimensional display device of claim 15 comprises
a regular display or regular monitor which may be either one of any type of LED display, any type of OLED display, any type of OLED display, any type of LCD display, any type of TFT display, any type of plasma display, any type of display or monitor which is used in the industry as a display and/or monitor or screen.
a software application which transform the 2 Dimensional image and/or 2 Dimensional video and/or 3 Dimensional perspective image and/or 3 Dimensional perspective video, into a format which is compatible with the 3 D display. The software application transform the image or video, to a compatible mode with the display, in order to achieve the desired stereoscopic view and there by provide the 3D viewing experience to the viewer.

17. The method of fabricating the passive 3 dimensional display of claim 15 comprises all or a few of the following components:
a transparent substrate or sheet, consisting a collection of lenticular lenses or lenticular lens array.
a collection of parallel lines array.
The lenticular lens array and parallel lines array combined together to form the 3D display which provides/enables the stereoscopic view and stereoscopic display.
Multiple layers of optically transparent material having different refractive indices
Multiple layers of optically transparent material having different refractive indices being stacked together.

18. The transparent substrate or sheet of claim 15, be attached onto the display or display screen of the camera, mobile phone, ipad, tab, laptop, PC monitor, or other applicable device.
